(19) United States
(12) Patent Application Publication
(10) Pub. No.: US 2021/0348031 A1
(43) Pub. Date: Nov. 11, 2021

(54) HOT MELT COMPOSITION

(71) Applicant: Henkel AG & Co. KGaA, Duesseldorf (DE)

(72) Inventors: Masaaki Dobashi, Kanagawa (JP); Takahide Morishita, Osaka (JP); Koji Shirai, Osaka (JP); Shingo Tsuno, Kanagawa (JP)

(21) Appl. No.: 17/383,857

(22) Filed: Jul. 23, 2021

Related U.S. Application Data
(63) Continuation of application No. PCT/JP2020/002027, filed on Jan. 22, 2020.

(30) Foreign Application Priority Data
Jan. 23, 2019 (JP) 2019-008877

(51) Int. Cl. C09J 5/06; C09J 11/08; C09J 123/12; C09J 123/16; B32B 5/18; B32B 27/06; B32B 27/32; B32B 7/12

(52) U.S. Cl. CPC C09J 5/06; C09J 11/08; C09J 123/12; C09J 123/16; B32B 5/18; B32B 2266/025; B32B 27/32; B32B 7/12; C09J 2423/16; C09J 2423/10; C09J 2491/00; B32B 27/065

(57) ABSTRACT

An objective of the present invention is to provide a hot melt composition which (i) is excellent in adhesion and heat resistance, and (ii) is not transferred to a surface of a substrate when the substrates pre-coated with the hot melt composition are stacked and stored. The present invention relates to a hot melt composition comprising: (A) an amorphous poly-α-olefin, (B) a crystalline propylene-based polymer, and (C) a tackifier resin, wherein the amorphous poly-α-olefin (A) comprises (A1) an amorphous poly-α-olefin having a softening point of 150° C. or more.

### TECHNICAL FIELD

The present invention relates to a hot melt composition, a substrate coated with the hot melt composition and the like. More specifically, the present invention relates to a hot melt composition suitable for pre-coating a skin material or the like in a lamination of a vehicle interior material.

### BACKGROUND ART

Instrument panels, door trims and the like, which are interior materials for vehicles such as automobiles, comprise, as base substrates, olefin-based resins such as polypropylene, ABS resins, vinyl chloride resins and the like. Usually, a skin material such as a polypropylene foam or a urethane foam is laminated on these base substrates in order to further impart good appearance and good hand feeling to the base substrates.

As the adhesive used for a lamination of the base substrate and the skin material, a solvent-based adhesive including a rubber-based or urethane-based adhesive has been often used. However, in the solvent-based adhesives, there have been safety and environmental problems during storage or application, and odor problems due to residual solvents. In addition, when the rubber-based adhesive is used, it is necessary to apply the adhesive to a base substrate immediately before laminating the base substrate and a skin material, which increases the work man-hours on site.

On the other hand, as a measure that can reduce work man-hours on site, there has been a method in which a skin material is pre-coated with a one-component moisture-curing urethane adhesive, and in a lamination process, the skin material pre-coated with a one-component moisture-curing urethane adhesive is heated to reactivate the adhesive, and the skin material is bonded to the base substrate. However, the moisture-curing urethane-based adhesive requires a moisture control equipment for an appropriate reaction rate and has a problem in stability during long-term storage.

As an adhesive for solving these problems, Patent Literature 1 and Patent Literature 2 describe non-reactive polyolefin-based hot melt adhesives for automobile interior materials.

### CITATION LIST

### Patent Literature

Patent Literature 1: Japanese Patent No. 4095972
Patent Literature 2: Japanese Patent Laid-Open No. 2009-126991

### SUMMARY OF INVENTION

### Technical Problem

However, when the pre-coated skin materials using the hot melt adhesive of Patent Literature 1 are stacked and stored, the adhesive is partially transferred from the surface to which the adhesive is applied to the surface of the contacting skin material by stacking up, which causes a problem of damaging the appearance. Furthermore, although the heat resistance in Patent Literature 2 is examined at 80° C., the more severe heat resistance in the vehicle interior is required due to recent environmental problems such as global warming. Thus, heat resistance at 90° C. or higher, and in some cases at 100° C. may be required. In fact, it has been found that the dashboard under the hot weather in summer becomes 90° C. or higher. However, the heat resistance of the adhesive of Patent Literature 2 is insufficient.

An object of the present invention is to provide a hot melt composition which (i) is capable of being used for lamination of vehicle interior materials, (ii) is excellent in adhesion and heat resistance, and (iii) is not transferred to the surface of a substrate such as a skin material when the substrate pre-coated with the hot melt composition is stacked up and stored.

### Solution to Problem

As a result of extensive studies to solve the above problems, the present inventors have found that a hot melt adhesive having the heat resistance at a high temperature can be obtained by combining an amorphous poly-α-olefin having a predetermined softening point, a crystalline propylene-based polymer, and a tackifier resin.

The present invention and preferred embodiment of the present invention are as follows.

A hot melt composition comprising:

(A) an amorphous poly-α-olefin,

(B) a crystalline propylene-based polymer, and

(C) a tackifier resin,

wherein the amorphous poly-α-olefin (A) comprises (A1) an amorphous poly-α-olefin having a softening point of 150° C. or more.

The hot melt composition according to the above item 1, wherein the crystalline propylene-based polymer (B) comprises a crystalline propylene-based polymer having a melt flow rate of 5 to 400 g/10 min as measured at 230° C. under a load of 2.16 kg.

The hot melt composition according to the above item 1 or 2, further comprising (D) a wax.

A polyolefin-based substrate coated with the hot melt composition according to any one of the above items 1 to 3.

A vehicle interior material comprising the polyolefin-based substrate according to the above item 4.

A vehicle comprising the vehicle interior material according to the above item 5.

### Advantageous Effects of Invention

According to the present invention, a hot melt composition being excellent in adhesion and heat resistance can be provided. Moreover, the substrate which is pre-coated with the hot melt composition of the present invention can suppress the transfer of the hot melt composition when the substrates are stacked up and stored.

### DESCRIPTION OF EMBODIMENTS

One embodiment of the present invention relates to a hot melt composition comprising: (A) an amorphous poly-α-olefin, (B) a crystalline propylene-based polymer, and (C) a tackifier resin, wherein the amorphous poly-α-olefin (A) comprises (A1) an amorphous poly-α-olefin having a softening point of 150° C. or more.

The hot melt composition of the present invention is excellent in adhesion and heat resistance and can maintain high adhesion even when placed under high temperature conditions after bonding. Further, even when the hot melt composition of the present invention is applied in advance (i.e., pre-coating) to a skin material of a vehicle interior material and the like, the composition is hardly transferred and is excellent in non-transferability.

Each component will be explained below.

<(A) Amorphous Poly-α-Olefin>

In the present invention, the amorphous poly-α-olefin refers to an amorphous polymer (having no clear melting point) among polymers obtained by polymerizing α-olefins. The amorphous poly-α-olefin is generally referred to as APAO (amorphous poly alpha olefin). Herein, the amorphous poly-α-olefin is also described as “component (A)” or “APAO”.

“Amorphous” means that the poly-α-olefin does not have a clear melting point. For example, it means that no clear peak (preferably a peak of 0.5 J/g or more) is observed when the melting point is measured by DSC (differential scanning calorimetry).

In the present specification, the amorphous poly-α-olefin may comprise a monomer unit based on ethylene in addition to a monomer unit based on an α-olefin. The amorphous poly-α-olefin may be a homopolymer or a copolymer. As the α-olefin, an α-olefin having 3 to 15 carbon atoms is preferable, and an α-olefin having 3 to 10 carbon atoms is more preferable. The monomer unit constituting the amorphous poly-α-olefin is not particularly limited, but preferably comprises a monomer unit based on an α-olefin having 3 to 15 carbon atoms and a monomer unit based on ethylene, and more preferably comprises a monomer unit based on an α-olefin having 3 to 10 carbon atoms and a monomer unit based on ethylene. Examples of the poly-α-olefin constituting the amorphous poly-α-olefin include polypropylene, polybutene, copolymers of propylene and other α-olefin(s), and copolymers of ethylene and other α-olefin(s). In the case of a copolymer, it may be a random copolymer or a block copolymer. Examples of the copolymer include a propylene/ethylene copolymer, a propylene/1-butene copolymer, an ethylene/propylene/1-butene terpolymer, a propylene/1-hexene/1-octene terpolymer, a propylene/1-hexene/methylpentene terpolymer and the like which are amorphous.

The hot melt composition of the present invention comprises preferably an amorphous poly-α-olefin having a softening point of 150° C. or more, more preferably an amorphous polyαolefin having a softening point of 160° C. or more. In the present specification, (A1) an amorphous poly-α-olefin having a softening point of 150° C. or more is also referred to as “component (A1)”. The upper limit value of the softening point of the component (A1) is not particularly limited, but is usually 250° C. or less, preferably 230° C. or less, more preferably 210° C. or less. Here, in the present specification, the softening point is a value measured by an automatic softening point apparatus (ring and ball type) according to the petroleum asphalt test based on JIS K 2207.

The weight average molecular weight of the component (A1) is not particularly limited, but is preferably 35,000 to 200,000, and more preferably 50,000 to 150,000. In the present specification, the weight average molecular weight is measured by gel permeation chromatography (GPC) using a calibration curve using monodisperse molecular weight polystyrene as a standard substance to calculate a molecular weight.

When the hot melt composition comprises a component (A1), heat resistance in addition to adhesiveness is improved.

Examples of commercial products of (A1) APAO having a softening point of 150° C. or more include VESTOPLAST 888, VESTOPLAST 828, VESTOPLAST EP807, VESTOPLAST EP827 and VESTOPLAST 891 manufactured by Evonik Corporation, RT2104, RT2115, RT2119 and RT2180 manufactured by REXtac, LLC., and UT2115 manufactured by Ube Industries, Ltd., and the like.

The component (A1) may be used alone or in combination of two or more.

The hot melt composition of the present invention may comprise as component (A), (A2) APAO having a softening point of less than 150° C. (also referred to as “component (A2)”) in addition to the component (A1). The use of both of the component (A1) and the component (A2) enables improvement of the flexibility of the hot melt composition.

The weight average molecular weight of the component (A2) is not particularly limited, but is preferably 35,000 to 200,000, and more preferably 40,000 to 150,000.

Examples of commercial products of (A2) APAO having a softening point of less than 150° C. include VESTOPLAST 308, VESTOPLAST 408, VESTOPLAST 520, VESTOPLAST 703, VESTOPLAST 704, VESTOPLAST 708, VESTOPLAST 750, VESTOPLAST 751 and VESTOPLAST 792 manufactured by Evonik Corporation, RT2215, RT2535, RT2585, RT2730 and RT2780 manufactured by REXtac, LLC., UT2535, UT2780 and UT2315 manufactured by Ube Industries, Ltd., and the like.

The component (A2) may be used alone or in combination of two or more.

The amount of the component (A) based on 100 parts by weight of the total amount of the components (A), (B) and (C) is preferably 10 to 90 parts by weight, more preferably 20 to 80 parts by weight, still more preferably 30 to 70 parts by weight, and still further preferably 50 to 70 parts by weight.

The amount of the component (A1) based on 100 parts by weight of the total amount of the components (A), (B) and (C) is preferably 20 to 80 parts by weight, and more preferably 30 to 70 parts by weight. The amount of the component (A2) based on 100 parts by weight of the total amount of the components (A), (B) and (C) is preferably 0 to 50 parts by weight, and more preferably 10 to 40 parts by weight.

The amount of the component (A1) based on the total amount of 100 parts by weight of the component (A) is preferably 30 parts by weight or more, more preferably 40 parts by weight or more, further preferably 50 parts by weight or more, and may be 100 parts by weight.

<(B) Crystalline Propylene-Based Polymer>

In the present invention, (B) a crystalline propylene-based polymer (also referred to as “component (B)”) is a homopolymer of propylene (polypropylene) having a crystallinity or a copolymer of propylene as a main component and other monomer components having a crystallinity. The term “having a crystallinity” means that it has a clear melting point, for example, a clear peak (preferably a peak of 0.5 J/g or more) is observed when the melting point is measured by DSC (differential scanning calorimetry).

In the component (B), the content of the monomer unit based on propylene to the total weight of the crystalline propylene-based polymer(s) is preferably 50% by weight or more, more preferably 70% by weight or more and may be 100% by weight.

When the component (B) is a copolymer of propylene and other monomer component(s), examples of other monomer components include, but are not particularly limited to, ethylene and α-olefins other than propylene. The α-olefin other than propylene is preferably an α-olefin having 4 to 10 carbon atoms. Examples of other monomer components include ethylene, 1-butene, 1-hexene, 1-octene and the like.

The crystalline propylene-based polymer preferably has a weight average molecular weight of 35,000 or more, more preferably 40,000 or more, and the upper limit thereof is not particularly limited, but is preferably 500,000 or less.

The crystalline propylene-based polymer is not particularly limited, but when the composition comprises the crystalline propylene-based polymer having a melt flow rate at 230° C. (under a load of 2.16 kg) of preferably 5 to 400 g/10 minutes, more preferably 5 to 350 g/10 minutes, the heat resistance of the hot melt composition is improved and thus the hot melt composition can be used for various purposes. The crystalline propylene-based polymer preferably comprises a crystalline polypropylene, and more preferably comprises a crystalline polypropylene having a melt flow rate at 230° C. (under a load of 2.16 kg) of 5 to 400 g/10 min. The melt flow rate at 230° C. (under a load of 2.16 kg) of the crystalline polypropylene is more preferably 5 to 350 g/10 min. The melt flow rate in the present invention means an index indicating the fluidity of the resin. Specifically, a predetermined amount of the synthetic resin is heated at a predetermined temperature (for example, at 230° C.) and is pressurized under a predetermined load (for example, 2.16 kg) in a cylindrical container heated by a heater, and the amount of the resin extruded per 10 minutes from the opening (nozzle) at the bottom of the container is determined as the melt flow rate. A measurement method described in ASTM D1238 is employed, and the unit of “g/10 min” is used. The amount of the crystalline propylene polymer having a melt flow rate at 230° C. (a load of 2.16 kg) of 5 to 400 g/10 min is preferably 30 parts by weight or more, more preferably 50 parts by weight or more, and may be 100 parts by weight, based on 100 parts by weight of the total amount of component (B).

In one embodiment of the present invention, a combination of a crystalline polypropylene having a melt flow rate at 230° C. (under a load of 2.16 kg) of 5 to 400 g/10 min and a crystalline polypropylene having a melt flow rate at 230° C. (under a load of 2.16 kg) of more than 400 g/10 min and 1000 g/10 min or less may be preferable because application suitability under various conditions is improved.

Examples of commercial products of the crystalline polypropylene having a melt flow rate at 230° C. (under a load of 2.16 kg) of 5 to 400 g/10 min include TAFMER PN2070, TAFMER PN2060, TAFMER PN3560 and TAFMER PN20300 manufactured by Mitsui Chemicals, Inc., L-MODU-S901 and L-MODU-S600 manufactured by Idemitsu Kosan Co., Ltd., SABIC PP-FPC100 manufactured by SABIC, NOVATEC PP-BCO8F manufactured by Japan Polypropylene Corporation, and Sun Allomer VMD81M manufactured by Sun Allomer Ltd.

Examples of commercial products of the crystalline polypropylene having a melt flow rate at 230° C. (under a load of 2.16 kg) of more than 400 g/10 min and 1000 g/10 min or less include Prime Polypro E239 manufactured by Prime Polymer Co., Ltd. and L-MODU-S400 manufactured by Idemitsu Kosan Co., Ltd.

The component (B) may be used alone or in combination of two or more.

The amount of the component (B) based on 100 parts by weight of the total amount of the components (A), (B) and (C) is preferably 1 to 20 parts by weight, more preferably 2 to 18 parts by weight, still more preferably 3 to 15 parts by weight.

<(C) Tackifier Resin>

Examples of the tackifier resin (C) (also referred to as “component (C)”) may include natural rosins, modified rosins, hydrogenated rosins, glycerol esters of natural rosins, glycerol esters of modified rosins, pentaerythritol esters of natural rosins, pentaerythritol esters of modified rosins, pentaerythritol esters of hydrogenated rosins, copolymers of natural terpenes, three-dimensional polymers of natural terpenes, hydrogenated derivatives of copolymers of hydrogenated terpenes, polyterpene resins, hydrogenated derivatives of phenol-based modified terpene resins, aliphatic petroleum hydrocarbon resins, hydrogenated derivatives of aliphatic petroleum hydrocarbon resins, aromatic petroleum hydrocarbon resins, hydrogenated derivatives of aromatic petroleum hydrocarbon resins, cyclic aliphatic petroleum hydrocarbon resins and hydrogenated derivatives of cyclic aliphatic petroleum hydrocarbon resins. These tackifier resins may be used alone or in combination. For the tackifier resin, liquid type tackifier resins can also be used as long as they are colorless to pale yellow in color tone, have substantially no odor, and have good thermal stability. Considering these properties comprehensively, as the tackifier resin, hydrogenated derivatives of resins and the like are preferred, and hydrogenated dicyclopentadiene-based resin is particularly desirable.

Examples of commercial products of the tackifier resin (C) include T-REZ HB-103 manufactured by TonenGeneral, ARKON P100, ARKON M100 and ARKON P140 manufactured by Arakawa Chemical Industries, Ltd., CLEARON M105 manufactured by YASUHARA CHEMICAL Co., Ltd., ECR5400 and ECR179EX manufactured by Exxon Mobil Corporation, and Quinton DX390 manufactured by Zeon Corporation. These commercial tackifier resins may be used singly or in combination.

The amount of the component (C) based on 100 parts by weight of the total weight of the components (A), (B) and (C) is preferably 10 parts by weight or more, more preferably 15 parts by weight or more, and 40 parts by weight or less, more preferably 35 parts by weight or less.

The total amount of the components (A), (B) and (C) based on 100 parts by weight of the total amount of the hot melt composition of the present invention is not particularly limited, but it is preferably 60 parts by weight or more, more preferably 70 parts by weight or more, and the upper limit thereof may be 100 parts by weight, but is preferably 90 parts by weight or less, more preferably 85 parts by weight or less.

<(D) Wax>

The hot melt composition of the present invention preferably comprises (D) a wax (also described as “component (D)”). The “wax” herein means an organic substance which is in a solid form at a normal temperature and becomes liquid when heated, has a weight average molecular weight of less than 35,000, and is generally called “wax”. There is no particular limitation as long as it has a wax-like property and the hot melt composition according to the present invention can be obtained. The wax may be an acid-modified product modified with a carboxylic acid or the like.

Examples of the wax include:

synthetic waxes such as a Fischer-Tropsch wax, a polyolefin wax (for example, a polyethylene wax, a polypropylene wax, a polyethylene/polypropylene wax);

petroleum waxes such as a paraffin wax and a microcrystalline wax;

natural waxes such as a castor wax; and the like. The wax may be used alone or in combination of two or more.

The hot melt composition of the present invention preferably comprises, but not limited to, a Fischer-Tropsch wax (also described as a “FT wax”). A “FT wax” herein means the wax which is synthesized by Fischer-Tropsch method and generally defined as a Fischer-Tropsch wax. The Fischer-Tropsch wax is a wax fractionated from a wax including component molecules with a relatively wide distribution of the number of carbon atoms so as to include component molecules with a narrow distribution of the number of carbon atoms. The FT wax may comprise a product modified with an acid such as a carboxylic acid. When the hot melt composition comprises the FT wax, the transfer of the composition is easily suppressed when the skin material pre-coated with the hot melt composition is stacked up and stored.

Examples of the commercial Fischer-Tropsch wax include SASOL H1, SASOL H8, SASOL H105, and SASOL C80 manufactured by Sasol Limited and paraffin wax FT-100 and paraffin wax FT-0070 manufactured by Nippon Seiro Co., Ltd.

The hot melt composition of the present invention may comprise a wax other than a FT wax, preferably comprises a FT wax and a wax other than a FT wax, and more preferably comprises a FT wax and a propylene-based wax (preferably polypropylene wax). When the composition comprises two or more types of waxes, transfer of the adhesive can be suppressed under a wide range of conditions when the pre-coated skin material is stacked and stored.

Examples of the commercial waxes other than a FT wax include Hi WAX NP-105 manufactured by Mitsui Chemicals, Inc., VISCOL 660P (trade name), VISCOL 550P (trade name), VISCOL 440P (trade name) and VISCOL 330P (trade name) manufactured by Sanyo Chemical Co., Ltd., and Honeywell A-0596P manufactured by Honeywell and the like.

The amount of the component (D) based on 100 parts by weight of the total amount of the components (A), (B) and (C) is preferably 15 parts by weight or more, more preferably 20 parts by weight or more, and preferably 40 parts by weight or less, more preferably 35 parts by weight or less. The amount of the component (D) based on 100 parts by weight of the total amount of the hot melt composition is preferably 8 parts by weight or more, more preferably 10 parts by weight, and preferably 35 parts by weight or less, more preferably 30 parts by weight or less.

The hot melt composition of the present invention may further comprise various additives as necessary. Examples of such additives may include a stabilizer and a modifier.

The “stabilizer” is blended to prevent reduction of molecular weight, gelation, coloration, generation of an odor and the like in the hot melt adhesive by heating and improve the stability of the hot melt adhesive. The “stabilizer” is not particularly limited as long as the hot melt adhesive targeted by the present invention can be obtained. Examples of the “stabilizer” include an antioxidant and an ultraviolet absorbing agent.

The “ultraviolet absorbing agent” is used to improve the light resistance of the hot melt composition. The “antioxidant” is used to prevent the oxidative degradation of the hot melt composition. The antioxidant and the ultraviolet absorbing agent are not particularly limited as long as they are generally used for hot melt adhesive products and can constitute the targeted hot melt adhesive.

Examples of the antioxidant include phenol-based antioxidants, sulfur-based antioxidants and phosphorus-based antioxidants. Examples of the ultraviolet absorbing agent include benzotriazole-based ultraviolet absorbing agents and benzophenone-based ultraviolet absorbing agents. A lactone-based stabilizer may also be added. These may be used alone or in combination.

As commercial products of the stabilizer, the following products may be used. Specific examples thereof include SUMILIZER GM (trade name), SUMILIZER TPD (trade name) and SUMILIZER TPS (trade name) manufactured by Sumitomo Chemical Co., Ltd., IRGANOX 1010 (trade name), IRGANOX HP2225FF (trade name), IRGAFOS 168 (trade name) and IRGANOX 1520 (trade name) manufactured by Ciba Specialty Chemicals, JF77 (trade name) manufactured by Johoku Chemical Co., Ltd. These stabilizers may be used alone or in combination.

The hot melt composition of the present invention may further comprise a modifier. As the modifier, for example, (F) a styrene-based block copolymer may be added to improve the toughness of the adhesive. Examples of commercial products of various styrene-based block copolymers include KRATON G1701 (trade name) and KRATON G1702HU (trade name) manufactured by Kraton corporation, Septon 4055 (trade name), Septon 4077 (trade name), Septon 1001 (trade name) and Septon 1020 (trade name) manufactured by Kuraray Co., Ltd., and the like.

As a modifier, (G) zinc oxide may be added to further improve heat resistance. Examples of commercial product of zinc oxide include AZO (trade name) manufactured by AZO Corporation.

The hot melt composition of the present invention is produced by blending the component (A), the component (B) and the component (C), and if necessary, component (D) and/or various additives, and mixing them with heating and melting. For example, the above components were charged into a melt-mixing pot equipped with a stirrer or a heating kneader and were mixed with heating to prepare the product. The order of adding the components, the heating method and the like are not particularly limited as long as the targeted hot melt composition can be obtained.

The method for applying the hot melt composition is not particularly limited as long as a desired product can be obtained. Such application methods may be broadly divided into contact application and noncontact application. The “contact application” refers to an application method in which an ejection machine is brought into contact with a member or a film when the hot melt composition is applied. The “noncontact application” refers to an application method in which an ejection machine is not brought into contact with a member or a film when the hot melt composition is applied. Examples of the contact application method may include slot coater coating and roll coater coating. Examples of the noncontact application method may include spiral coating which allows coatings in the form of a spiral, omega coating and control seam coating which allows coatings in the form of a wave, slot spray coating and curtain spray coating which allows coatings in the form of a plane, and dot coating which allows coatings in the form of dots.

One embodiment of the present invention relates to a substrate to which the hot melt composition is applied, and preferably a polyolefin-based substrate to which the hot melt composition is applied. In this specification, the polyolefin-based substrate refers to a substrate comprising a polyolefin-based compound. The polyolefin-based substrate may have a laminated structure having a layer comprising a polyolefin-based compound and a layer comprising no polyolefin-based compound, but it is preferable that at least one surface of the laminate is a layer comprising a polyolefin-based compound. When the polyolefin-based substrate is composed of a plurality of layers, the hot melt composition is preferably applied on the surface of the layer comprising the polyolefin-based compound. The polyolefin-based compound refers to a homopolymer or a copolymer of olefins such as ethylene, propylene, and butene, and is preferably a propylene-based compound having a propylene-based unit and is more preferably polypropylene. As the polyolefin-based substrate, a skin material of a vehicle interior material (automobile interior material or the like) or a substrate obtained by laminating a skin material and a base substrate is particularly preferable. In one embodiment of the present invention, a skin material of an automobile interior material as a polyolefin-based substrate may be pre-coated with the hot melt composition. Another embodiment of the present invention relates to a laminate in which the skin material and the base substrate are bonded together by the hot melt composition wherein at least one of the skin material and the base substrate is a polyolefin-based substrate.

The hot melt composition of the present invention may be suitably used as an adhesive applied in advance (i.e. pre-coating) to a skin material for a vehicle interior material (preferably an automobile interior material). The skin material is preferably the above-mentioned polyolefin-based substrate. The skin material may be, for example, a material having a surface layer alone constituted by a plastic sheet made of polyvinyl chloride, thermoplastic polyolefin, or the like, or by a fibrous material such as a tricot, a woven fabric, or a nonwoven fabric; or a sheet-like material obtained by laminating a polyolefin-based foam and the above surface material layer by bonding or heat fusion, wherein the polyolefin-based foam is manufactured mainly from polypropylene, polyethylene, polybutylene, or a copolymer of two or more kinds selected from propylene, ethylene and butylene. The thickness of the skin material is not particularly limited, but is, for example, about 0.3 mm to 5 mm. In one embodiment of the present invention, the hot melt composition is applied to a surface of the skin material or the like so as to be a weight of, for example, 90 to 150 g/m².

One embodiment of the present invention relates to a vehicle interior material (preferably an automobile interior material) including a skin material (preferably a polyolefin-based substrate) to which the hot melt composition is applied. Examples of vehicle interior materials include, but are not limited to, instrument panels, doors, ceiling materials, rear trays, pillars, and the like.

One embodiment of the present invention relates to a vehicle having a vehicle interior material (preferably an automobile interior material) comprising a skin material (preferably a polyolefin-based substrate) to which the hot melt composition is applied. Examples of the vehicle according to the present invention include, but not particularly limited to, vehicles according to the Road Traffic Law such as railroad vehicles such as an electric railcar, a railroad car and a train, military vehicles such as a tank and an armored car, motor vehicles (automobiles), motor bicycles (motorcycles), buses, and streetcars. In the present specification, although a term “automobile interior material” is used in some sentences, the term may be construed to mean an interior material for vehicles other than automobiles as long as the hot melt composition of the present invention can be applied.

The hot melt composition of the present invention is excellent in adhesiveness and heat resistance. Therefore, it can be suitably used for bonding of a dashboard or the like that is exposed to high temperatures. The hot melt composition of the present invention is suitable for being applied in advance (i.e. pre-coating) to an interior material for a vehicle (preferably a skin material for an interior of an automobile). Even if the vehicle interior material (preferably a skin material) which is pre-coated with the hot melt composition of the present invention is stacked up and stored, the hot melt composition is not transferred. That is, the skin material which is pre-coated with the hot melt composition of the present invention can be stacked up and stored for a long period of time without deterioration of the hot melt adhesive layer over time, and therefore transportation without temperature control or the like can be achieved even in a transportation that takes one month or more such as import/export by ship.

### EXAMPLES

Hereinafter, the present invention will be described with reference to Examples and Comparative Examples, but these examples are for describing the present invention and do not limit the present invention at all.

The components used in the hot melt compositions of Examples and Comparative Examples are described below.

(A) Amorphous poly-α-olefin (having a softening point of 150° C. or more)

(Hereinafter, ethylene/propylene/1-butene copolymer)

(A-1) “VESTOPLAST 888” (trade name) manufactured by Evonik Corporation

Softening point: 161° C., weight average molecular weight: 104,000

(A-2) “VESTOPLAST 828” (trade name) manufactured by Evonik Corporation

Softening point: 161° C., weight average molecular weight: 61,000

(A-3) “VESTOPLAST EP807” (trade name) manufactured by Evonik Corporation

Softening point: 161° C.

(The following is a polypropylene homopolymer)
(A-4) “REXtac2180” (trade name) manufactured by REXtac, LLC.

Softening point: 155° C., weight average molecular weight: 70,700

(A′) Amorphous Poly-α-Olefin (Having a Softening Point of Less than 150° C.)

(The followings are ethylene/propylene/1-butene copolymer)
(A′-5) “VESTOPLAST 792” (trade name) manufactured by Evonik Corporation

Softening point: 108° C., weight average molecular weight 118,000

(A′-6) “VESTOPLAST 750” (trade name) manufactured by Evonik Corporation

Softening point: 107° C., weight average molecular weight 92,000

(A′-7) “VESTOPLAST 520” (trade name) manufactured by Evonik Corporation

Softening point: 87° C., weight average molecular weight 63,000

(A′-8) “VESTOPLAST 408” (trade name) manufactured by Evonik Corporation

Softening point: 118° C., weight average molecular weight 48,000

(A′-9) “VESTOPLAST 308” (trade name) manufactured by Evonik Corporation

Softening point: 136° C., weight average molecular weight 49,000

(B) Crystalline Propylene-Based Polymer

(B-1) “TAFMER PN2070” (trade name) manufactured by Mitsui Chemicals, Inc., (melt flow rate at 230° C.: 7 g/10 min, weight average molecular weight: 450,000)
(B-2) “L-MODU S901” (trade name) manufactured by Idemitsu Kosan Co., Ltd. (melt flow rate at 230° C.: 50 g/10 min, weight average molecular weight: 130,000, polypropylene homopolymer)
(B-3) “L-MODU S600” (trade name) manufactured by Idemitsu Kosan Co., Ltd. (melt flow rate at 230° C.: 350 g/10 min, weight average molecular weight: 75,000, polypropylene homopolymer)
(B-4) “Prime Polypro E239” (trade name) manufactured by Prime Polymer Co., Ltd.)

(melt flow rate at 230° C.: 540 g/10 min, weight average molecular weight: 90,000)

The melt flow rate is a value measured at 230° C. under a load of 2.16 kg according to the method described in ASTM D1238.

(C) Tackifier Resin

(C-1) “T-Rez HB-103” (trade name) manufactured by JXTG Nippon Oil & Energy Corporation

Softening point: 103° C., weight average molecular weight: 760 (C-2) “Alcon P140” (trade name) manufactured by Arakawa Chemical Industries, Ltd.

Softening point: 140° C., weight average molecular weight: 900

(D) Wax

(D-1) Fischer-Tropsch wax “Sasol Wax H105” (trade name) manufactured by Sasol Limited

weight average molecular weight: 1,100, melting point: 117° C.

(D-2) “Hi WAX NP105” (trade name) manufactured by Mitsui Chemicals, Inc.

weight average molecular weight: 11,000, melting point: 140° C.

(D-3) “VISCOL 660P” (trade name) manufactured by Sanyo Kasei Kogyo Co., Ltd.

weight average molecular weight: 8,000, softening point: 145° C.

(D-4) “Honeywell A-C 596P” (trade name) manufactured by Honeywell

weight average molecular weight: 34,000, dropping point: 141° C.

Additives

(E) Antioxidant

“Irganox 1010” (trade name) manufactured by BASF Japan Ltd.

(F) Styrene-Based Block Copolymer

SEBS “Clayton Polymer G 1657M” (trade name) manufactured by Kraton corporation

(G) Zinc Oxide

“Active Zinc Oxide AZO” (trade name) manufactured by Seido Chemical Industry Co., Ltd.

Specific surface area: 60 to 90 m²/g

The components (A) to (G) were melt-mixed in the blending ratios shown in Table 1 by a heating kneader (manufactured by MEC Co., Ltd., etc.) at about 180° C. to produce the hot melt compositions of Examples 1 to 7 and Comparative Examples 1 to 7, respectively. The unit of the blending amount described in the Table is “parts by weight”. Each of the prepared hot melt adhesives was applied to a foam surface of a skin material for an automobile interior by a roll coater heated to about 180° C. so as to be about 100 g/m² to obtain a pre-coated skin material, wherein the skin material for an automobile interior is a laminated product of a surface material TPO (olefin-based elastomer) and a PP (polypropylene) foam and has a thickness of 3 mm.

The obtained pre-coated skin materials were placed at room temperature for one day or more. Then, they were put into a dryer at 180° C. for about 3 minutes to re-activate (re-melt) the adhesive. Subsequently, within 10 seconds of the open time, the pre-coated skin materials were bonded to polypropylene substrates (KOBE POLYSHEET “PP—N-BN” having a thickness of 2 mm, manufactured by ETS) at room temperature (about 23° C.). Immediately after the bonding, a weight was applied to each of them for 10 seconds so that the pressure became 0.01 MPa, to obtain a laminated plate.

The laminated plate obtained as described above was cut into a width of 25 mm, and heat resistance was evaluated by a heat-resistant creep test. In addition, the non-transferability was evaluated using the pre-coated skin material obtained above.

<Heat Resistance Test (Thermal Creep Test) and Durability Test>

The skin material was peeled off from the laminate plate by about 2 cm, and a predetermined weight (100 g or 300 g) was attached to the portion of the skin material that was peeled off. The test piece was set so that the skin material on which the weight was attached and the laminate plate formed an angle of 90° and then placed in a dryer at a predetermined temperature (at 90° C. when using a 100 g weight and at 80° C. when using a 300 g weight, respectively). The test piece was taken out after 24 hours, and the movement distance of the adhesive interface between the skin material and the substrate was measured to determine the creep length. Further, when the creep length was 1 mm or more, the failure mode was visually observed.

As a durability test, after the laminate plate was heated at 200° C. for 48 hours, it was cooled to room temperature (about 23° C.), and then a thermal creep test was performed under the condition of a 100 g weight (90° C.×24 hours) in the same manner as the above heat resistance test.

The criteria for the thermal creep test are shown below.

∘: The creep length was 5 mm or less.
x: The creep length was more than 5 mm.

The criteria for the failure mode in the thermal creep test are shown below.

CF: cohesion failure (failure within the adhesive)
AF: adhesion failure (failure at the interface between the adhesive and the PP substrate)
MF: material failure (failure within the skin material)

<Non-Transferability Test>

The pre-coated skin material was placed at room temperature for 24 hours or more and then cut into a size of 50 mm×50 mm. Three cutout pre-coated skin materials were stacked so that the adhesive layer and the surface layer of the skin material (TPO surface side) were brought into contact with each other, and a load of 400 g (1.6 kPa) was uniformly applied to the upper part. The stacked test piece was placed at a predetermined temperature (40° C., 45° C. and 50° C., respectively) for one week, and then the surface layer of the skin material was visually observed and the presence or absence of transfer of the adhesive was confirmed based on whether there was gloss or the like. The criteria for the non-transferability test are as follows.

∘: No transfer was observed.
x: Significant transfer was observed.

Table 1 shows the components of each sample of Examples and Comparative Examples and the amounts thereof, and Table 2 shows the test results for heat resistance and non-transferability.

TABLE 1

| compo- | Ex. | Ex. | Ex. | Ex. | Ex. | Ex. | Ex. | Com.- | Com.- | Com.- | Com.- | Com.- | Com.- | Com.- |
|---|---|---|---|---|---|---|---|---|---|---|---|---|---|---|
| nent | 1 | 2 | 3 | 4 | 5 | 6 | 7 | Ex. 1 | Ex. 2 | Ex.3 | Ex. 4 | Ex. 5 | Ex. 6 | Ex. 7 |
| A-1 | | | | 37.5 | 37.5 | 37.5 | | | | 50.0 | 40.0 | 35.1 | | |
| A-2 | | | | | | | 34.6 | | | | | | | |
| A-3 | | | | | | | 23.2 | | | | | | | |
| A-4 | 63.2 | 68.8 | 63.2 | | | | | | | | | | | |
| A′-5 | | | | 31.3 | 31.3 | 31.3 | | | 68.8 | 41.7 | 33.3 | 29.3 | | |
| A′-6 | | | | | | | | | | | | | 76.9 | |
| A′-7 | | | | | | | | | | | | | | 76.9 |
| A′-8 | | | | | | | | | | | | | | |
| A′-9 | | | | | | | | 68.8 | | | | | | |
| B-1 | 13.8 | 6.3 | 13.8 | 6.3 | | | 6.6 | 6.3 | 6.3 | 8.3 | | | | |
| B-2 | | | | | 6.3 | | | | | | | | | |
| B-3 | | | | | | 6.3 | | | | | | | | |
| B-4 | | | | | | | 6.6 | | | | | 12.2 | | |
| C-1 | 23.0 | 25.0 | 23.0 | 25.0 | 25.0 | 25.0 | 28.9 | 25.0 | 25.0 | | 26.7 | 23.4 | | |
| C-2 | | | | | | | | | | | | | 23.1 | 23.1 |
| D-1 | 5.7 | 6.3 | 5.7 | 6.3 | 6.3 | 6.3 | 5.5 | 6.3 | 6.3 | 8.3 | 6.7 | 5.9 | | |
| D-2 | 26.4 | 18.8 | 26.4 | 18.8 | 18.8 | 18.8 | 11.0 | 18.8 | 18.8 | 25.0 | | 10.1 | | |
| D-3 | | | | | | | | | | | | | 61.5 | 61.5 |
| D-4 | | | | | | | 2.2 | | | | | | | |
| E | 0.9 | 1.0 | 0.9 | 1.0 | 1.0 | 1.0 | 1.0 | 1.3 | 1.3 | 1.7 | 1.3 | 1.2 | 1.5 | 1.5 |
| F | | | | | | | 7.5 | | | | | | | |
| G | | | 1.1 | | | | 0.3 | | | | | | | |
| total | 133.1 | 126.0 | 134.3 | 126.0 | 126.0 | 126.0 | 127.4 | 126.3 | 126.3 | 135.0 | 108.0 | 117.1 | 163.1 | 163.1 |

In the table, the unit of the numerical value for the content is “parts by weight”.
Ex. = Example,
Com.- Ex. = Comparative Example

TABLE 2

| | | Ex. | Ex. | Ex. | Ex. | Ex. | Ex. | Ex. | Com.- | Com.- | Com.- | Com.- | Com.- | Com.- | Com.- |
|---|---|---|---|---|---|---|---|---|---|---|---|---|---|---|---|
| | | 1 | 2 | 3 | 4 | 5 | 6 | 7 | Ex. 1 | Ex. 2 | Ex. 3 | Ex. 4 | Ex. 5 | Ex. 6 | Ex. 7 |
| Initial heat | creep | 0 | 0 | 0 | 0 | 0 | 2 | 0 | — | 28 | 0 | >40 | >40 | >40 | >50 |
| resistance | length | | | | | | | | | | | | | | |
| test 1 | [mm] | | | | | | | | | | | | | | |
| 300 g | failure | — | — | — | — | — | AF/CF | — | | CF/AF | — | CF/AF | CF/AF | CF | CF |
| 80° C. × | mode | | | | | | | | | | | | | | |
| 24 hours | evaluation | ∘ | ∘ | ∘ | ∘ | ∘ | ∘ | ∘ | | x | ∘ | x | x | x | x |
| Initial heat | creep | 1 | 2 | 2 | 5 | 0 | 0 | 2 | >40 | 6 | 0 | 0 | 0 | 0 | >40 |
| resistance test | length | | | | | | | | | | | | | | |
| 2 | [mm] | | | | | | | | | | | | | | |
| 100 g | failure | CF | AF/CF | AF/CF | MF/CF | — | — | AF/CF | CF/AF | CF/AF | — | — | — | — | MF/CF |
| 90° C. × | mode | | | | | | | | | | | | | | |
| 24 hours | evaluation | ∘ | ∘ | ∘ | ∘ | ∘ | ∘ | ∘ | x | x | ∘ | ∘ | ∘ | ∘ | x |
| durability test | creep | 0 | 1 | 0 | 0 | 5 | 4 | 2 | >40 | >40 | 25 | >40 | >40 | >40 | >40 |
| 200° C. × | length | | | | | | | | | | | | | | |
| 48 hours | [mm] | | | | | | | | | | | | | | |
| and then | failure | — | CF | — | — | CF | CF | CF | MF/CF | MF/CF | CF/AF | MF/CF | MF/CF | MF/CF | MF/CF |
| 100 g | mode | | | | | | | | | | | | | | |
| 90° C. × | evaluation | ∘ | ∘ | ∘ | ∘ | ∘ | ∘ | ∘ | x | x | x | x | x | x | x |
| 24 hours | | | | | | | | | | | | | | | |
| non- | 40° C. | ∘ | ∘ | ∘ | ∘ | ∘ | ∘ | ∘ | x | ∘ | ∘ | ∘ | ∘ | x | x |
| transferability | x1 week | | | | | | | | | | | | | | |
| | 45° C. | ∘ | ∘ | ∘ | ∘ | ∘ | ∘ | ∘ | x | ∘ | ∘ | x | x | x | x |
| | x1 week | | | | | | | | | | | | | | |
| | 50° C. | ∘ | ∘ | ∘ | ∘ | ∘ | ∘ | ∘ | x | x | ∘ | x | x | x | x |
| | x1 week | | | | | | | | | | | | | | |

Ex. = Example,
Com.- Ex. = Comparative Example

As shown in Table 2 above, the hot melt adhesives of Examples 1 to 7 passed the heat creep test under each condition and were found to have higher heat resistance than Comparative Examples 1 to 7.

The result of the non-transferability test is an indicator for the state that the pre-coated skin materials are stacked and stored. As shown in Table 2 above, Examples 1 to 7 passed the non-transferability test (that is, the adhesives were not transferred), and therefore it is shown that the adhesives of Examples 1 to 7 are excellent for use in stack and storage of the pre-coated skin material.

### INDUSTRIAL APPLICABILITY

The hot melt composition of the present invention has high heat resistance and can be suitably used for vehicle interior materials (preferably, automobile interior materials). In the manufacturing process of automobile interior materials and the like, since the skin material which is pre-coated with the hot melt composition of the present invention can be stacked and stored for a long period of time, it can be exported and imported overseas in the state of the pre-coated skin material. Thus, the manufacturing process of the automobile interior materials can be shortened.

1. A hot melt composition comprising:
(A) an amorphous poly-α-olefin,
(B) a crystalline propylene-based polymer, and
(C) a tackifier resin,
wherein the amorphous poly-α-olefin (A) comprises (A1) an amorphous poly-α-olefin having a softening point of 150° C. or more.

2. The hot melt composition according to claim 1, wherein the crystalline propylene-based polymer (B) comprises a crystalline propylene-based polymer having a melt flow rate of 5 to 400 g/10 min as measured at 230° C. under a load of 2.16 kg.

3. The hot melt composition according to claim 1, further comprising (D) a wax.

4. The hot melt composition according to claim 1, wherein the amorphous poly-α-olefin (A) further comprises (A2) an APAO having a softening point of less than 150° C.

5. A polyolefin-based substrate coated with the hot melt composition according to claim 1.

6. A vehicle interior material comprising the polyolefin-based substrate according to claim 5.

7. A vehicle comprising the vehicle interior material according to claim 6.
